(19) United States
(12) Patent Application Publication
(10) Pub. No.: US 2006/0120078 A1
(43) Pub. Date: Jun. 8, 2006

(54) Wallwasher downlight

(76) Inventor: Leonhard Klose, Ludenscheid (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 11/256,658

(22) Filed: Oct. 21, 2005

(30) Foreign Application Priority Data
Oct. 22, 2004 (DE) 102004051661.8

(51) Int. Cl. F21V 1/00; F21V 23/02

(52) U.S. Cl. 362/241; 362/240; 362/260

(57) ABSTRACT

A light fixture has a housing having an open side and a hollow shell secured to the housing, having an inwardly directed mirrored surface, and formed with a window. At least two different light sources of different colors cast light against the mirrored surface so that the light from the sources is reflected and mixed by the mirrored surface and passes out the window. A reflector secured to the housing is positioned to intercept light passing out of the shell through the window and reflect the intercepted light out of the housing.

The invention relates mainly to a light fixture according to the introductory clause of claim 1.

Such a light fixture of applicant is known from public use.

The invention also relates to an indoor light fixture that illuminates a building wall, for example a floor, ceiling or side wall inside a room, and to an outdoor light fixture that is secured to an outside wall of a building and illuminates a building from outside. In particularly the invention relates to a light fixture for emitting homogeneous and uniform light over a large surface of a building. The light fixture according to the invention can also be used to illuminate objects, for example, works of art.

It is worth noting that the light fixture according to the invention is mounted fixedly on a building, for example on a ceiling, floor, or wall or on the outside of a building.

The invention uses as starting point the so-called “Focalflood” light fixtures described on pages 486 to 487 of the catalog “Programm, Auggabe 2004/2005” of applicant. Here there is a flood light that has a lamp housing inside which are provided three differently colored T16 fluorescent lamps, namely a red, a green, and a blue fluorescent lamp.

The fluorescent lamps are individually controllable and produce a steplessly variable colored light for illuminating wall surfaces or facades. The three fluorescent lamps are oriented parallel to one another immediately adjacent a light opening. A diffusor and Softec™ lens serve for mixing the three basic colors at the light aperture so the mixed light colors appear perfectly uniform on the building surface being illuminated.

Starting from this know prior use of light fixtures of the applicant it is an object of the invention to improve on the known light fixture so that it is possible to produce an improved uniformly homogenous illumination of a building surface.

The invention achieves this object with the features of claim 1 according to which the light source assembly is formed by a generally closed internally mirrored hollow shell in which there are at least two differently colored light sources, for example two fluorescent lamps, and that has a light window through which color-mixed light from the light sources exits, the reflector being positioned such in a path between the light window and the light opening that at least the major portion of light emitted by the light source assembly is reflected by the reflector onto the building surface.

The basic idea of the invention is that there is inside the housing a separate assembly constituted by a hollow shell that holds the differently colored light sources and that has a mirrored inner surface so that an optimal mixing of colors takes place inside this hollow shell. The hollow shell has a light window through which the already homogeneously mixed light can exit. Then, before leaving the light fixture, the major portion of the light leaving the hollow shell strikes a reflector and is cast on the building surface being illuminated.

Unlike the standard prior-art light fixture the light is not mixed at the light window but instead is mixed before the light strikes a reflector inside the fixture. Then further transmission and reflection of already color-optimized and homogeneously mixed light is possible inside the light housing. The reflector can further add to the mixing. The light mixing is thus improved.

The use of a generally closed hollow shell ensures that the hollow shell has an accurately dimensioned light window and the remaining wall regions that define the hollow shell are opaque and in fact reflective and as a result of their mirroring ensure mixing of the light emitted by the light sources. It is worth noting that the mirroring can for example be done according to the invention by a metallic surface that is applied to a plastic hollow shell. Alternatively the mirroring can be a polished inner surface so as to produce multiple reflections inside the hollow shell. It is important that the inner surface of the hollow shell so reflects the light from the light sources that there are multiple reflections inside the hollow shell that ensure an optimal mixing of the light.

It is worth noting that the light window of the hollow shell can be a simple hole in the wall of the hollow shell or can be a partially transparent or translucent element which is at least partially mirrored on its inner face. In the latter case only a portion of the light emitted by the light sources and impinging on the inner surface of the element forming the light window passes through the light window and the rest of this light is reflected back and is thus available for further mixing with other light.

Inside the hollow shell there are two differently colored light sources, although more, for example three or four light sources, in particular elongated fluorescent lamps, can be used. In the case of three different light sources it is preferably that one is a red lamp, one a blue lamp, and one a green lamp. Alternatively several light sources with different white tones can be used so that by controlling the individual light sources, dimming or switching them, it is possible to obtain differently mixed white output tones.

The light sources can be standard-size or small fluorescent lamps, QT-DE lamps, high-voltage halogen lamps, etc. In the case of small-format fluorescent lamps the light colors can for example be produced by colored fluorescents. Alternatively the different colors of light can be produced by providing standard lamps with foil filters. In the case of high-voltage halogen lamps colored glass filter tubes can produce the different colors.

The light window of the hollow shell is advantageously formed by a translucent element. This can for example be made of two foils, namely an inner foil having a highly reflective inner surface and a structured outer surface. An outer foil can for example be formed as a diffusor for more color mixing.

The hollow shell can be made of sheet metal, for example aluminum, in the desired shape, for example cylindrically tubular. The translucent element that forms the light window can be extruded or injection-molded of plastic.

According to an advantageous embodiment of the invention the hollow shell is formed by a generally cylindrical element that extends along a body axis. In this manner a very long space is available for the light sources which allows for example the installation of T16 fluorescent lamps. In addition the space available for the mixing of the different light colors, namely the interior of the hollow shell, is quite large which improves the color mixing.

According to a further advantageous embodiment of the invention the hollow shell is of generally cylindrical section. In this manner a uniformly curved inner surface of the hollow shell ensures that with minimal volume there is very good color mixing.

According to a further advantageous embodiment of the invention the light window of the hollow shell extends over an angle between 90° and 150°, preferably about 120°. This makes it possible on the one hand to provide a sufficiently large light window so allow use of standard reflectors and prior-art light deflection so that the light-source assembly can for example replace a prior-art light-source assembly without having to otherwise change the light fixture. In this regard it is also worth noting that the light coming out of the light window of the hollow shell moves generally along a path that is shown below in the drawing at arrows P₁ and P₂. On the other hand a light window of this size ensures sufficient space for the color mixing of the light from the differently colored light sources.

According to a further advantageous embodiment of the invention the light window is partially opaque. This means that it is partially opaque and for example is constituted by a translucent lens. There is in particular the possibility of making the translucent lens of two laminated foils or the like. Preferably the light window has a mirrored inner surface so that a portion of the light is reflected back into the interior of the hollow shell and there can be multiply reflected. The remaining portion of the light passes through the light window of the hollow shell and strikes the reflector.

According to a further advantageous embodiment of the invention the light window is an elongated slot. It can thus extend generally the full axial length of the hollow shell. This makes construction of the hollow shell particularly simple.

According to a further advantageous embodiment of the invention a length of the light window generally corresponds to a length of the light sources. This makes a particularly homogeneous and efficient illumination of the building surface possible.

According to a further advantageous embodiment of the invention the light sources are elongated along respective axes. This makes possible a homogenous illumination of a large area of the building surface.

According to a further advantageous embodiment of the invention the light sources emit light rotation symmetrically from their (longitudinal) axes. The light sources are thus as seen in section points that spread or distribute light over 360°. Such a rotation-symmetrical or at least not directed light emission is known for example from standard axially elongated fluorescent lamps. Such a light source makes it possible to mix colors extremely well and the light fixture according to the invention makes it possible to mix the light of differently colored light sources inside the hollow shell so as to be homogeneous and this mixed light can exit the hollow shell through the light window in a predetermined direction and thus be further acted on inside the light fixture and bounced or deflected by a reflector with a predetermined curvature.

According to a further advantageous embodiment of the invention the light sources are parallel to one another. This makes it possible for the light-source assembly to be particularly compact and achieve a particularly good color mixing.

According to a further advantageous embodiment of the invention the light sources are parallel to the hollow shell center axis. This makes it possible for the light-source assembly to be particularly compact.

According to a further advantageous embodiment of the invention the light sources are fluorescent lamps. This makes it possible to use standard light sources so that known connectors and the like, for example lamp sockets, contacts, etc. can be used.

The invention relates further to a light-source assembly for illuminating a building surface or portion thereof according to the introductory clause of claim 14. In particular such an assembly can be used in the above-described light fixture.

The invention is based on a light-source assembly that is known from the above-described prior-art “Focalflood” light fixtures of applicant. Here there are three fluorescent lamps grouped together by lateral brackets to form a light-source assembly. This light-source assembly is mounted inside a housing that is closed by a diffusor plate. Inside the housing there is a separate reflector that partially surrounds the light-source assembly.

Starting from this state of the art it is an object of the invention to develop a light-source assembly that ensures improved color mixing.

The invention achieves this object with the features of claim 14, in particular its characterizing clause, and is characterized by a generally closed and internally mirrored hollow shell holding at least two differently colored light sources, e.g. two fluorescent lamps and having a light window through which exits the color-mixed light emitted by the light sources.

The principle of the invention is thus generally that the light-source unit is provided in a generally closed hollow shell having a light window. The hollow shell is internally mirrored and can be of circular section. A light opening can extend over about 120°. The light window can advantageously have a translucent lens, for example with a diffusor.

The light-source assembly can be mounted in a housing, preferably in different housings. It can directly illuminate the building surface or the light can only exit the light opening after bouncing off a reflector inside the housing to illuminate the building surface. Preferably the color-mixed light leaves the light window of the hollow shell along its extension direction.

The light-source assembly can be used directly as a light fixture without a separate housing and for example be provided at the ends of the hollow shell with connector mounts, preferably switching devices, and hung from the ceiling. In this case the walls of the hollow shell themselves form the housing and the inner surface of the hollow shell is mirrored. A separate housing is unnecessary in this case.

It is worth noting that the light-source unit described here, which is fixed in a housing, can also be used without a housing as a light-source assembly. Similarly the described light-source assembly can be mounted in a light-fixture housing which functions without a separate reflector so that the light-source assembly casts light directly on the building surface.

Further advantages of the invention are seen in the uncited dependent claims as well as with reference to the following description of an embodiment shown in the drawing. Therein:

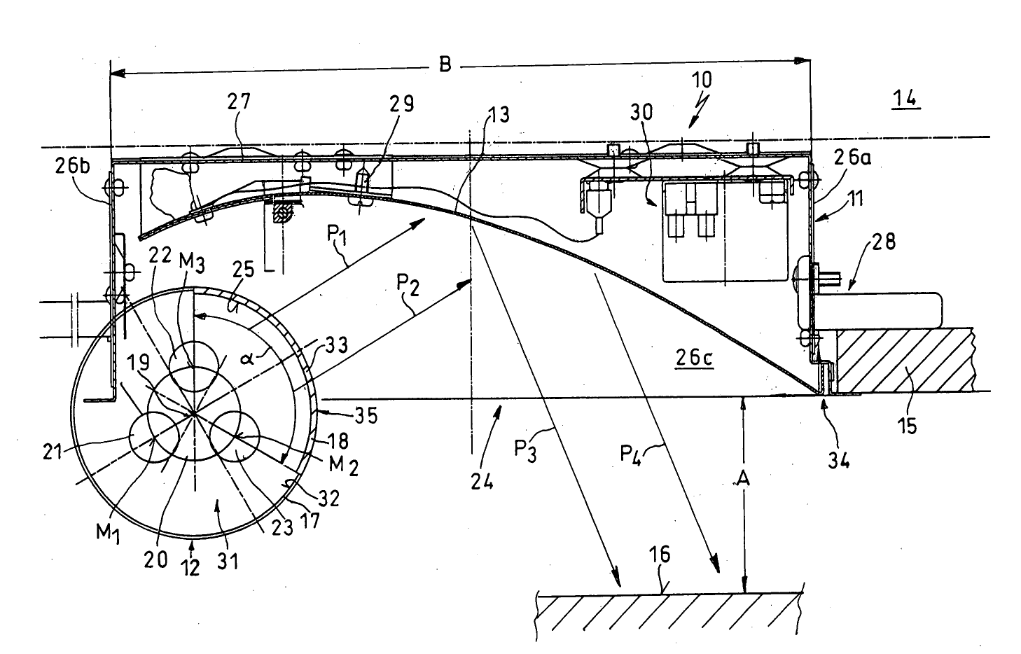

FIG. 1 is a partial sectional schematic view of an embodiment of the light fixture according to the invention.

The light fixture according to the invention is shown generally at 10. It has a generally box-like housing 11, on the housing 11 a light source assembly 12 that is at least partially and preferably completely inside the housing 11, and a reflector 13.

The box-shaped housing 11 has side walls 26a, 26b, and 26c, an unillustrated fourth side wall, and a wall 27 forming a floor of the housing 11.

The light fixture 10 is secured here inside a building on a ceiling 14 shown only schematically. To this end partially illustrated clips 28 are provided that engage behind a suspended ceiling 15 and secure the light fixture 10 in this manner in the building.

The reflector 13 is secured by fasteners 29 to the housing 11. Between the reflector 13 and the housing 11 there are circuit elements shown generally and schematically at 30 that for example include the electrical connections for the light source, for example also the transformer, capacitor, etc.

The light source assembly 12 is only shown schematically and is connected in a way not shown here with the housing 11, in particular with the side wall 26b of the housing 11. The light source assembly 12 described in more detail below emits light as shown by arrows P₁ and P₂ generally along a direction (shown by arrows) which engages the reflector 13 and is generally redirected along the arrows P₃ and P₄ against a wall 16 of the room. The wall 16 is thus the building surface being illuminated.

It is worth noting that the distance A between the suspended ceiling 15 and the floor is shown much smaller than it really is and the scale of the light fixture 10 relative to this distance A is not accurate. Normally the distance A is several meters, for example 3 m. A width B of the housing 11 is in fact for example between about 10 and 50 cm.

The light source assembly 12 is formed by a generally cylindrically tubular hollow body 17 that for example is made of sheet metal, in particular aluminum. A light window slot 18 extends over an angle a of 120° through the hollow shell 17. Light can exit an interior 31 of the hollow shell 17 only through the window 18 as shown by arrows P₁ and P₂. The remaining 240° portion of the hollow shell 17 is opaque.

Inside the cylindrically circular space there are three light sources, preferably three fluorescent lamps 21, 22, and 23. The fluorescent lamps generate light of different colors and here there is for example a red, a green, and a blue fluorescent lamp. The fluorescent lamp have respective geometric axes M₁, M₂, and M₃ that are parallel to a center axis 19 of the hollow shell 17. The three fluorescent lamps 21, 22, and 23 are thus parallel to one another and also parallel to the hollow shell 17 that extends perpendicular to the plane of the view.

FIG. 1 further shows that the centers M₁, M₂, and M₃ lie on a circle centered on the center axis 19 of the hollow shell. The three fluorescent lamps 21, 22, and 23 are thus equispaced from the center 19 of the hollow shell 17. In addition the three fluorescent lamps 21, 22, and 23 are angularly equidistantly oriented.

An inner surface 32 of the hollow shell 17 is mirrored so that light emitted by the individual light sources 21, 22, and 23 rotation symmetrically from their axes M₁, M₂, and M₃ is multiply reflected on the inner surface 32. There is thus very homogeneous mixing of the colors inside the hollow shell 17.

The color-mixed light exits through the light window 18. This light window 18 is covered by a translucent lens 33 that is mirrored on its inner face 25. The translucent lens 33 is for this reason only partially transparent so that a portion of the light impinging the inner face 25 of the element from the three fluorescent lamps 21, 22, and 23 is reflected back into the interior and is available there for further mixing, so that the remaining portion leaves the hollow shell 17 through the light window 18.

The overwhelming portion of the light emitted by the three light sources 21, 22, and 23 after leaving through the light window 18 strikes the reflector 13 and is then directed against the floor 16. Depending on the actual position of the light fixture 10 and depending on the actual position of the light source assembly 12, light window 18, reflector 13, and light opening 24 some light will pass directly out. Preferably however the entire light output or at least a very large portion of the light output is reflected by the reflector 13 and then cast on the building surface. 16.

The light fixture according to the invention very thoroughly mixes the light emitted by the light sources 21, 22, and 23 inside the hollow shell 17 and makes it available at the light window 18. This color-mixed light is reflected by the reflector 13 so that its color is further homogenized. The building surface 16, which for example can be of fairly large area, can be very homogeneously illuminated without any of the colors of the individual light sources 21, 22, or 23 being individually detectable so that the building surface 16 will have no color variations. The light from the three light sources 21, 22, and 23 can be varied by dimming or switching the individual light sources. This mixed light thus produces for this reason a homogeneous one-color light.

The translucent lens 33 can be made of two foils that are welded or laminated together. A first inner foil on the inner face can be mirrored and the outer foil can be structured. The second outer foil can be made like a diffusor.

In the embodiment of FIG. 1 the three light sources 21, 22, and 23 are standard T16 fluorescent lamps 1149 mm long. Thus the hollow shell 17 is of the same length or slightly longer, measured perpendicular to the view plane. The housing 11 and the entire light fixture 10 is longer than one of the fluorescent lamps so as to allow fitting of the hollow shell 17 with the light sources inside the housing 11.

The fluorescent lamps are mounted in standard sockets or seats either directly on the housing or directly on the hollow shell.

It is worth noting that the symmetrical arrangement of the light sources inside the hollow shell 17 can be different. Even the number and type of light sources can be varied. The geometrical shape of the hollow shell 17 can be made to conform to other types of light sources. Preferably however elongated lamps are used that emit light uniformly from their axes M₁, K₂, and M₃.

The light opening 24 is the embodiment of FIG. 1 is delimited by a lateral edge 35 of the reflector 13 and a side edge 34 of the translucent lens 33. Homogeneously color-mixed light, that is one-color light, passes through this light opening 24. The light opening 24 is in FIG. 1 a simple opening. It can also be formed by a lens, an cover, a piece of glass, under circumstances also provided with light-spreading elements or a prismatic lens.

It is worth noting that the translucent lens 33 can be for example and extruded plastic profile. It can also be removable from the hollow shell 17, for example hinged, so that when the lens 33 is opened there is access to the interior 31, for example to be able to change a lamp.

It is worth noting that the translucent lens 33 can also be called a diffusor. It is advantageously directly mounted on the hollow shell 17, for example at edges of its arced sheet metal. A separate fastener for securing the diffusor 33 on the light housing is thus unnecessary.

In addition it is particularly meaningful that the inner surface 25 of the translucent lens 33 is curved and forms a smooth continuation of the curvature of the inner face 32 of the hollow shell 17. In this manner a uniformly and continuously curved interior 31 is achieved that ensures a particularly effective color mixing of the light.

The light source assembly 12 can be formed by a tuned, that is light-optimized system, and be used in different housings. The light source can for example be in different lengths and used like a module. Thus different lamps with different geometric relationships of the housing and the reflector can use the same light source.

1. A light fixture (10) for illuminating a building surface (16) or portion thereof and having a housing (11), a light source assembly (12), at least one reflector (13), and a light opening (24), characterized in that the light source assembly (12) is formed by a generally closed internally mirrored hollow shell (17) in which there are at least two differently colored light sources (21, 21, and 23), for example two fluorescent lamps, and that has a light window (18) through which color-mixed light from the light sources exits, the reflector (13) being positioned such in a path (P₁, P₂, P₃, and P₄) between the light window (18) and the light opening (24) that at least the major portion of light emitted by the light source assembly (12) is reflected by the reflector onto the building surface (16).

2. The light fixture according to claim 1, characterized in that the hollow shell (17) is formed by a generally cylindrical element that extends along a body axis (19).

3. The light fixture according to claim 1 or 2, characterized in that the hollow shell (17) is of generally cylindrical section.

4. The light fixture according to one of the preceding clams, in particular claim 3, characterized in that the light window (18) on the hollow shell (17) extends over an angle between 90° and 150°, preferably about 120°.

5. The light fixture according to one of the preceding claims, characterized in that the light window (18) is partially opaque.

6. The light fixture according to one of the preceding claims, the light window (18) has a mirrored inner surface.

7. The light fixture according to one of the preceding claims, characterized in that the light window (18) is an elongated slot.

8. The light fixture according to claim 7, characterized in that a length of the light window (18) generally corresponds to a length of the light sources (21, 22, and 23).

9. The light fixture according to one of the preceding claims, characterized in that the light sources (21, 22, and 23) are elongated along respective axes (M₁, K₂, and M₃).

10. The light fixture according to claim 9, characterized in that the light sources (21, 22, and 23) emit light rotation symmetrically from their axes (M₁, M₂, and M₃).

11. The light fixture according to one of the preceding claims, characterized in that the light sources (21, 22, and 23) are parallel to one another.

12. The light fixture according to claim 2, characterized in that the light sources (21, 22, and 23) are parallel to the shell center axis (19).

13. The light fixture according to one of the preceding claims, characterized in that the light sources (21, 22, and 23) are fluorescent lamps.

14. A light source assembly (12) for illuminating a building surface (16) or portion thereof, in particular for use in a light fixture according to the preceding claims, characterized by a generally closed and internally mirrored hollow shell (17) holding at least two differently colored light sources (21, 22, and 23), e.g. two fluorescent lamps and having a light window (18) through which exits the color-mixed: light emitted by the light sources.
